(19) United States
(12) Patent Application Publication
(10) Pub. No.: US 2007/0266993 A1
(43) Pub. Date: Nov. 22, 2007

(54) Method and device for operating an internal combustion engine

(76) Inventors: Thomas Kettl, Atting (DE); Hong Zhang, Tegernheim (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/749,982

(22) Filed: May 17, 2007

(30) Foreign Application Priority Data
May 18, 2006 (DE) DE 102006023473.1

(51) Int. Cl. F02P 5/00; F02M 7/00

(52) U.S. Cl. 123/406.24; 123/435; 123/406.41; 123/436

(57) ABSTRACT

An internal combustion engine has a plurality of cylinders, at least one cylinder being configured as a reference cylinder to which a cylinder pressure sensor is assigned, wherein at least one control element is assigned to each of the cylinders and provision is made for a crankshaft angle sensor. A combustion parameter is determined depending on the measurement signal (MS) of the cylinder pressure sensor, the combustion parameter being characteristic for the combustion process of the air/fuel mixture in the reference cylinder. At least one control variable for at least one control element is adjusted in relation to a plurality of cylinders depending on the combustion parameter, in the sense of adjusting the combustion process in the reference cylinder to a preset combustion process.

### CROSS-REFERENCE TO RELATED APPLICATIONS

This application claims priority from German Patent Application No. 10 2006 023 473.1, which was filed on May 18, 2006, and is incorporated herein by reference in its entirety.

### TECHNICAL FIELD

The invention relates to a method and device for operating an internal combustion engine having a plurality of cylinders. Such an internal combustion engine can be petrol-driven or diesel-driven, for example.

### BACKGROUND

As a result of increasingly strict statutory regulations concerning permissible pollutant emissions of motor vehicles which include internal combustion engines, it is necessary to keep the pollutant emissions as low as possible during operation of the internal combustion engine. This can be done firstly by reducing the pollutant emissions which occur during the combustion of the air/fuel mixture in the respective cylinder of the internal combustion engine. Secondly, internal combustion engines make use of exhaust gas post-treatment systems which convert the pollutant emissions that are generated during the combustion process of the air/fuel mixture in the respective cylinders into harmless substances. In all approaches, precise control of the internal combustion engine can contribute to keeping the pollutant emissions low in a suitable manner.

Demanding requirements in respect of driving comfort also mean that precise control of the internal combustion engine is necessary.

### SUMMARY

A method and a corresponding device can be designed to be simple and allow precise operation of an internal combustion engine having a plurality of cylinders. According to an embodiment, a method for operating an internal combustion engine having a plurality of cylinders, at least one cylinder being configured as a reference cylinder to which a cylinder pressure sensor is assigned, wherein at least one control element is assigned to each of the cylinders and provision is made for a crankshaft angle sensor, may comprise the steps of determining a combustion parameter depending on a measurement signal of the cylinder pressure sensor, said combustion parameter being characteristic for the combustion process of an air/fuel mixture in the reference cylinder, and adjusting at least one control variable for at least one control element with respect to a plurality of cylinders depending on the combustion parameter to adjust the combustion process in the reference cylinder to a preset combustion process.

### BRIEF DESCRIPTION OF THE DRAWINGS

Exemplary embodiments are explained in greater detail below with reference to the schematic drawings, in which:

FIG. 1 shows an internal combustion engine,

FIG. 2 shows a flow diagram of a first program for operating the internal combustion engine,

FIG. 3 shows a flow diagram of a second program for operating the internal combustion engine,

FIG. 4 shows a flow diagram of a third program for operating the internal combustion engine, and

FIG. 5 shows a flow diagram of a fourth program for operating the internal combustion engine.

Elements of identical construction or function are identified using the identical reference signs throughout the figures.

### DETAILED DESCRIPTION

According to an embodiment, a method and a corresponding device for operating an internal combustion engine having a plurality of cylinders are provided. At least one of the cylinders is configured as a reference cylinder, to which a cylinder pressure sensor is assigned. At least one control element is assigned to each of the cylinders. Provision is further made for a crankshaft angle sensor. A combustion parameter is determined depending on the measurement signal of the cylinder pressure sensor. The combustion parameter is characteristic for the combustion process of the air/fuel mixture in the reference cylinder. At least one control variable for at least one control element is adjusted in relation to a plurality of cylinders depending on the combustion parameter, in the sense of adjusting the combustion process in the reference cylinder to a preset combustion process.

In this way, advantage can be taken of the finding that the adjustment of the control variable for at least one control element which is assigned to the reference cylinder depending on the combustion parameter, in the sense of adjusting the combustion process in the reference cylinder to a preset combustion process, can be transferred easily to further cylinders, e.g. all cylinders of a cylinder block or also e.g. all further cylinders of the internal combustion engine. In this way, the expense of the required sensor technology, i.e. in particular the number of cylinder pressure sensors, is significantly reduced while nonetheless allowing very precise control of the internal combustion engine.

According to an embodiment, the combustion parameter is representative for a focal point (center) of the combustion of the air/fuel mixture in the reference cylinder. It is evident in this context that the combustion parameter is then particularly suitable for allowing very precise operation of the internal combustion engine.

According to a further embodiment, the combustion parameter is determined depending on a pressure focal point (center) which is derived from the measurement signal of the cylinder pressure sensor and relates to the compression stroke and the working stroke of the reference cylinder. In this context, advantage can be taken of the finding that the pressure focal point correlates to the focal point of the combustion. According to a further embodiment, the combustion parameter is representative for a velocity of the combustion of the air/fuel mixture in the reference cylinder. In this context again, advantage can be taken of the finding that very precise operation of the internal combustion engine is possible if the velocity of the combustion is known.

The velocity of the combustion is understood to mean, in particular, the velocity of the propagation of the relevant flame front.

In this context, it may be advantageous if the combustion parameter is determined depending on a maximal gradient of the pressure in the reference cylinder during the combustion of the air/fuel mixture in the reference cylinder, said gradient being derived from the measurement signal of the cylinder pressure sensor. The maximal gradient is characterized in that it correlates very closely to the velocity of the combustion of the air/fuel mixture in the reference cylinder and is easy to determine.

According to a further embodiment, the at least one control variable for at least one control element influences an exhaust gas return or a preinjection quantity to be metered or a position of a main injection pattern relative to the crankshaft angle or an ignition angle, in respect of a plurality of cylinders. A main injection pattern can be characterized by a single injection pulse, for example, but also by a plurality of injection pulses. In this way, the adjustments can be carried out particularly precisely in relation to the plurality of cylinders.

According to a further embodiment, an acceleration parameter for an angular acceleration during the combustion of the air/fuel mixture in the respective cylinder is determined in a cylinder-specific manner during quasi-stationary operation of the internal combustion engine. In this case, advantage can be taken of the finding that the angular acceleration during the combustion of the air/fuel mixture is representative in each case of the respective torque contribution which is generated by the respective combustion in the respective cylinder.

At least one control variable is adjusted in a cylinder-specific manner in each case, in the sense of a balancing of the acceleration parameters assigned to the respective cylinders. In this way, an equalization of the torque contributions that are generated in the respective cylinders can be carried out easily and reliably, and specifically in relation to each other. In conjunction with the adjustment of the at least one control variable for at least one control element in relation to a plurality of cylinders depending on the combustion parameter, in the sense of the adjustment of the combustion process in the reference cylinder to the preset combustion process, it is also possible to achieve a perfectly accurate setting of the torque contributions in the respective cylinders. This allows particularly precise and hence also comfortable control of the internal combustion engine.

In this context, it can be advantageous if the at least one control variable which must be cylinder-specifically adjusted influences a fuel quantity that is to be metered into the respective cylinder. It is possible thus to influence the respective absolute torque contribution in a particularly simple and precise manner.

In this context, it may be further advantageous if the at least one control variable which must be cylinder-specifically adjusted influences a position, relative to the crankshaft angle, of a main injection pattern into the respective cylinder. It is also possible thus to influence the respective absolute torque contribution in a particularly simple and precise manner.

According to a further embodiment, the acceleration parameter is cylinder-specifically determined depending on the angular acceleration during the combustion of the air/fuel mixture in the respective cylinder. This is particularly precise.

According to a further embodiment, the acceleration parameter is determined depending on the time duration of an angle segment which can be preset. This is particularly simple. An angle segment is understood to mean a preset angle range relative to the crankshaft angle, which is preferably based on a respective reference point relative to the individual cylinder, e.g. a top dead center of the upper piston.

In this context, it may be particularly advantageous if the angle segment is the respective cylinder segment. The cylinder segment is that crankshaft angle range, within a work cycle of an internal combustion engine, during which the respectively generated torque can be allocated to one of the cylinders in each case. The crankshaft angle range which is occupied by a cylinder segment is, in the case of a four-stroke internal combustion engine, 720° of crankshaft angle divided by the number of cylinders.

According to a further embodiment, an actual torque is determined depending on the measurement signal of the cylinder pressure sensor. A torque model, whose output variables are control variables, is adjusted depending on the actual torque for a plurality of cylinders. This then allows particularly precise control of the torque.

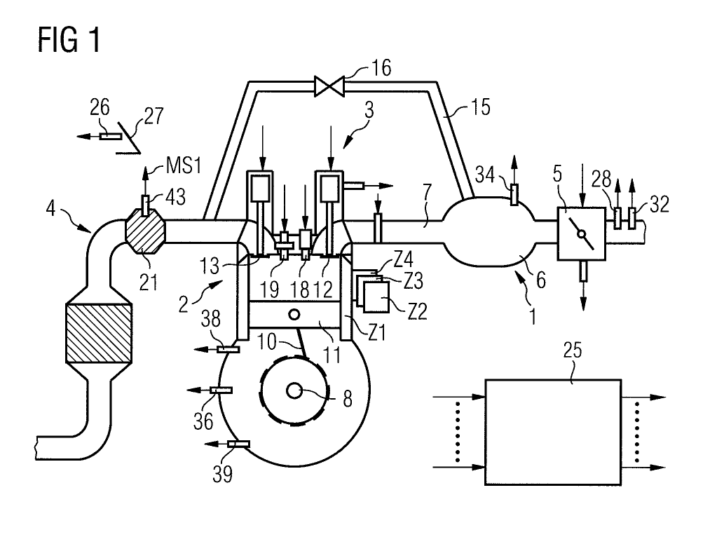

An internal combustion engine (FIG. 1) comprises an intake channel 1, an engine block 2, a cylinder head 3 and an exhaust channel 4. The intake channel 1 preferably comprises a throttle valve 5, a manifold 6 and a suction pipe 7 which leads to a cylinder Z1 via an inlet port in the engine block. The engine block 2 also comprises a crankshaft 8 which is coupled to the piston 11 of the cylinder Z1 via a connecting rod 10.

The cylinder head 3 comprises a valve gear with a gas inlet valve 12 and a gas outlet valve 13. The cylinder head 3 also comprises an injection valve 18 and possibly a spark plug 19. Alternatively, the injection valve 18 can also be arranged in the suction pipe 7.

Provision is made for an exhaust gas return 15 via which exhaust gas can be returned to the intake channel 1 depending on a setting of an exhaust gas return valve 16.

A catalytic converter 21 is provided in the exhaust channel 4.

Provision is made for a control device 25 which is assigned sensors that capture various measured variables and determine the value of the measured variable in each case. Operating variables comprise the measured variables and variables derived therefrom. Depending on at least one of the operating variables, the control device determines control variables which can then be converted into one or more control signals for controlling the control elements of the internal combustion engine by means of corresponding servomechanisms. The control device can also be referred to as a device for operating the internal combustion engine.

The internal combustion engine has a plurality of cylinders Z1-Z4, corresponding control elements and possibly also sensors being assigned to the respective cylinders Z1-Z4 in each case.

The sensors comprise a pedal position sensor 26 which captures an accelerator pedal position of an accelerator pedal 27, an air mass sensor 28 which captures an air mass flow upstream of the throttle valve, a first temperature sensor 32 which captures an intake air temperature, a suction pipe pressure sensor 34 which captures the suction pipe pressure in the manifold 6, a crankshaft angle sensor 36 which captures a crankshaft angle that is then assigned a rotational speed, and a second temperature sensor 38 which captures a temperature within the crankshaft housing.

Furthermore, a cylinder Z1 which is configured as a reference cylinder is assigned a cylinder pressure sensor 39 whose measurement signal is representative for a pressure profile in the reference cylinder.

Provision is made for an exhaust gas sensor 43 which can be arranged in the catalytic converter 21 or also upstream of the catalytic converter and captures a residual oxygen content of the exhaust gas.

Depending on the embodiment of the internal combustion engine, provision can be made for any subset of the cited sensors or also for additional sensors.

The control elements are e.g. the throttle valve 5, the gas inlet and outlet valves 12, 13, the exhaust gas return valve 16, the injection valve 18 or the spark plug 19. In particular, the throttle valve 5 and the spark plug 19 can be omitted in the case of a diesel-driven internal combustion engine.

Programs for operating the internal combustion engine are stored in a memory of the internal combustion engine and are processed in the control device 25 during the operation of the internal combustion engine.

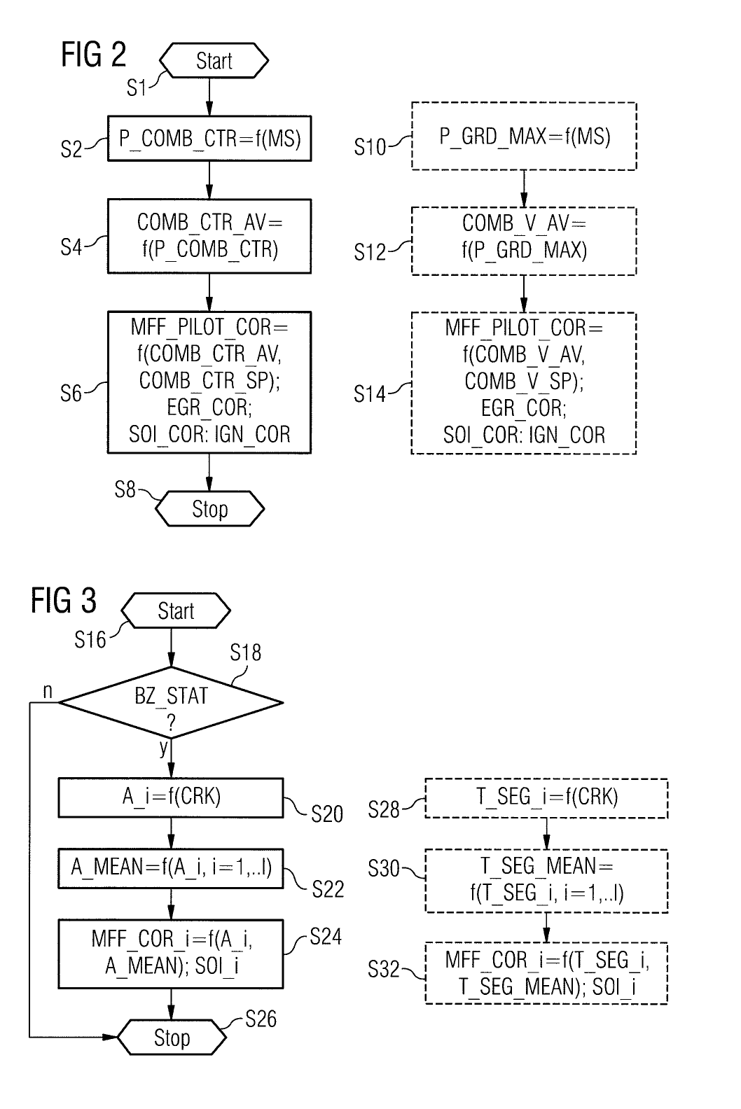

A first program for operating an internal combustion engine, said program being depicted in FIG. 2, is started at a step S1 in which variables are initialized if applicable. The start can take place during operation at presettable time intervals, for example. However, it can also take place if preset operating variables have specific values or value ranges.

In a step S2, a pressure focal point (center) P_COMB_CTR is determined over the compression stroke and the working stroke of the reference cylinder depending on the measurement signal MS of the cylinder pressure sensor 39.

In a step S4, a focal point (center) COMB_CTR_AV of the combustion of the air/fuel mixture in the reference cylinder Z1 is then determined, and specifically depending on the pressure focal point P_COMB_CTR over the compression stroke and the working stroke of the reference cylinder Z1. This can be done, for example, by means of a direct time equation of the focal point COMB_CTR_AV of the combustion with the pressure focal point P_COMB_CTR. However, provision can be made for a correlating time offset between the two if applicable in this context.

In a step S6, a preinjection quantity correction value MFF_PILOT_COR is then determined depending on the focal point COMB_CTR_AV of the combustion and a preset focal point COMB_CTR_SP of the combustion of the air/fuel mixture in the reference cylinder Z1, and specifically in the sense of a balancing of the two in relation to each other. For this purpose, provision can also be made for a regulator, for example, which can feature e.g. a P part, an I part or a D part. The preinjection quantity correction value MFF_PILOT_COR can also be determined depending on a characteristic map.

The determining of the preinjection quantity correction value MFF_PILOT_COR preferably takes place with reference to the relevant current load point, wherein this can be preset e.g. by means of a torque which is to be adjusted.

Alternatively or additionally, an exhaust gas return rate correction value EGR_COR and/or an injection start angle correction value SOI_COR for correcting an injection start angle SOI of a main injection pattern can also be determined in a corresponding manner and, like the preinjection quantity correction value MFF_PILOT_COR, stored in the memory of the control device for the further portion of the internal combustion engine. This preferably takes place in the sense of an adaptation, wherein a characteristic map can be provided for this depending on operating variables. It is thus possible to store the correction values determined in the step S6 e.g. assigned to a load variable such as the torque which is to be adjusted. The correction values are preferably stored in the sense of an adaptation.

The method is finally terminated in a step S8.

It is also possible alternatively to omit the step S4 and, instead, the calculations in the step S6 then take place correspondingly depending on the pressure focal point P_COMB_CTR and a correspondingly preset pressure focal point.

Alternatively or additionally to the steps S2 to S6, provision can also be made for steps S10 to S14. In a step S10, a maximal gradient P_GRD_MAX of the pressure in the reference cylinder during the combustion of the air/fuel mixture in the reference cylinder is determined depending on the measurement signal MS of the cylinder pressure sensor 39. This preferably takes place within a crankshaft angle window between approximately top dead center during the combustion and approximately 30° to 40° of the crankshaft angle thereafter.

In a step S12, a velocity COMB_V_AV of the combustion of the air/fuel mixture in the reference cylinder is determined, and specifically depending on the maximal gradient P_GRD_MAX of the pressure in the reference cylinder during the combustion of the air/fuel mixture. This preferably takes place by means of a permanently preset and predetermined assignment rule, e.g. by means of a proportional assignment.

Finally, in a step S14, the preinjection quantity correction value MFF_PILOT_COR is determined depending on the velocity COMB_V_AV of the combustion and a preset velocity COMB_V_SP of the combustion of the air/fuel mixture in the reference cylinder Z1 corresponding to the procedure of the step S6. Alternatively or additionally, the injection start angle correction value SOI_COR and/or the exhaust gas return rate correction value EGR_COR are determined in the step S14 correspondingly.

In a similar manner to the step S4 described above, the step S12 can also be omitted here and a correspondingly adjusted calculation can take place in the step S14. If both the steps S6 and S14 are carried out, both an adjustment of the focal point COMB_CTR_AV to the preset focal point COMB_CTR_SP of the combustion and an adjustment of the velocity COMB_V_AV of the combustion to the preset velocity COMB_V_SP of the combustion are preferred accordingly when determining the correction values.

The correction values determined in the steps S16 and/or S14 are applied in relation to a plurality of cylinders Z1-Z4 in the further operation of the internal combustion engine. In this case, these can be e.g. the cylinders Z1-Z4 of a cylinder block or e.g. all cylinders Z1-Z4 of the internal combustion engine.

In a step S16 (FIG. 3), a second program is started. Variables can be initialized if applicable in the step S16. The second program is preferably started at presettable time intervals during the operation of the internal combustion engine. However, it can also be started if a subset of the operating variables have presettable values or value ranges.

In a step S18, a check establishes whether quasi-stationary operation BZ_STAT of the internal combustion engine is present. The quasi-stationary operation BZ_STAT is typically characterized by an essentially constant rotational speed and an essentially constant torque, and specifically over a plurality of work cycles. If the condition of the step S18 is not satisfied, the second program is preferably terminated in the step S26. If the condition of the step S18 is satisfied, however, an angle acceleration A_i during the combustion of the air/fuel mixture in the respective cylinder Z1 to Z4 is determined in a step S20.

An “i” is a substitute for the respective cylinder Z1 to Z4 and therefore could also be represented as an index. The substitute “i” can have a value from 1 to I, wherein I corresponds to e.g. the number of cylinders Z1-Z4 in a cylinder block or even to the total number of cylinders Z1-Z4 in the internal combustion engine.

In a step S22, a mean angle acceleration A_MEAN is determined by averaging the angle accelerations A_i determined in the step S20 during the combustion of the air/fuel mixture in the respective cylinders.

In a step S24, a cylinder-specific fuel quantity correction value MFF_COR_i for the respective cylinder Z1-Z4 is finally determined depending on the respectively assigned angle acceleration A_i during the combustion and the mean angle acceleration A_MEAN, and specifically in the sense of a balancing of the respective angle acceleration A_i of the respective cylinder Z1-Z4 in relation to the mean angle acceleration A_MEAN. For this purpose, provision can be made for e.g. a corresponding regulator or, for example, the respective cylinder-specific fuel quantity correction value MFF_COR_I can be determined depending on a characteristic map. A cylinder-specific injection start angle correction value SOI_COR_i in each case can also be determined correspondingly in the step S24.

The correction values determined in the step S24 are then preferably stored, in a cylinder-specific manner and preferably in relation to the load point that is currently present, in the memory of the control device 25 for the further operation. For this, provision can be made for e.g. a characteristic map in which the respective cylinder-specific correction values can be stored according to load point. The adjustment of the respective characteristic map values preferably takes place in the sense of an adaptation.

The method is finally terminated in the step S26.

Alternatively to the steps S20 to S24, provision can also be made for steps S28 to S32. The steps S28 to S32 correspond to the steps S20 to S24, with the difference that in each case angle segment time durations and in particular preferably cylinder segment time durations T_SEG_i are determined on a cylinder-specific basis as an acceleration parameter for the angle acceleration during the combustion of the air/fuel mixture in the respective cylinders Z1 to Z4, these being determined on a cylinder-specific basis, and a mean cylinder segment time duration T_SEG_MEAN is determined in the step S30.

The program according to FIG. 3 is terminated in a step S26.

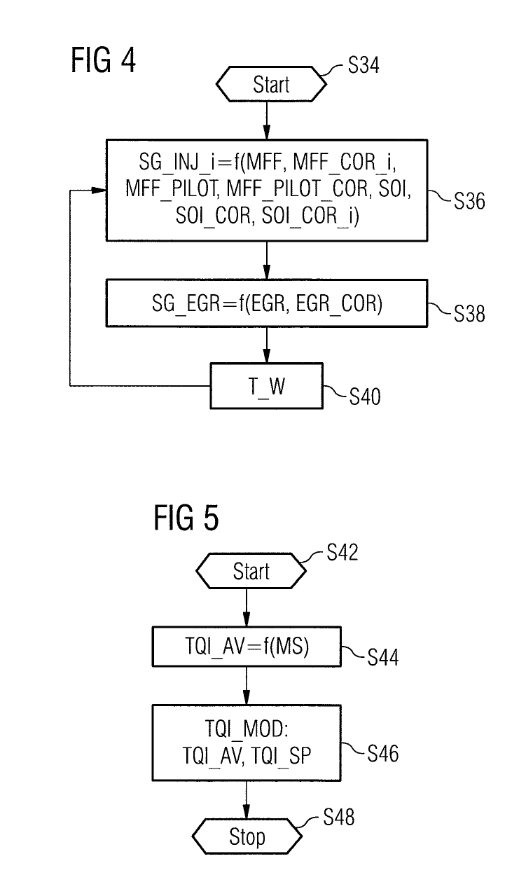

A third program (FIG. 4) is started in a step S34. Variables can be initialized in the step S34, for example. The start of the third program is preferably time-linked to an engine start of the internal combustion engine.

In a step S36, cylinder-specific control signals SG_INJ_i are determined for the respective injection valves 18 which are assigned to the respective cylinders Z1 to Z4. For this, e.g. by means of further functions which are stored in the control device in the form of programs, a fuel quantity MFF to be metered and/or a preinjection quantity MFF_PILOT to be metered and/or an injection start angle SOI are preset with regard to a main injection pattern. The injection start angle is therefore representative of a crankshaft angle-related position of the main injection pattern. The main injection pattern can comprise e.g. only one injection pulse; however, it can also comprise a plurality of injection pulses.

The respective cylinder-specific fuel quantity correction value MFF_COR_i and/or the respective cylinder-specific injection start angle correction value SOI_COR_i and/or the respective assigned preinjection quantity correction value MFF_PILOT_COR are also determined. This activity is preferably load-dependent or also dependent on the value of further operating variables, taking into consideration the correction values determined in the steps S6 and/or S14 and/or S24 and/or S32 accordingly. Finally, the respective injection valve 18 is then activated correspondingly by means of the cylinder-specific control signal SG_INJ_i.

In a step S38 which can also be carried out in quasi-parallel with the step S36, a control signal SG_EGR for the exhaust gas return valve 16 is determined depending on an exhaust gas return rate EGR, this being determined by another program of the control device, and the exhaust gas return rate correction value EGR_COR. In this context, the exhaust gas return rate correction value EGR_COR is likewise preferably determined depending on a load or depending on further operating variables depending on a corresponding characteristic map, whose characteristic map values are correspondingly adjusted or adapted when the steps S6 or S14 are correspondingly executed.

The exhaust gas return valve 16 is then activated according to the control signal SG_EGR. In a step S40, the program preferably pauses for a presettable time duration which can also correspond to a presettable crankshaft angle, this being preferably preset such that the steps S36 and S38 are processed e.g. once per cylinder segment in each case.

Provision can also be made for a fourth program which is explained in greater detail below with reference to the flow diagram in FIG. 5. The fourth program is started in a step S42, in which variables can be initialized if applicable. The start in the step S42 can take place e.g. at presettable time intervals during the operation of the internal combustion engine.

In a step S44, an actual torque TQI_AV is determined depending on the measurement signal MS of the cylinder pressure sensor 39. In a step S46, a torque model TQI_MOD, whose output variables are control variables, is then adjusted depending on the current torque TQI_AV. This is preferably done by comparing a corresponding desired torque TQI_SP with the determined actual torque TQI_AV. Such a torque model is disclosed e.g. in the Handbuch Verbrennungsmotor, 2nd edition, June 2002, Friedrich Vieweg & Sohn Verlaggesellschaft mbH, Braunschweig/Wiesbaden, pages 554-556, whose content is relevant in relation to this subject matter.

The adjustment of the torque model TQI_MOD preferably takes place adaptively. Moreover, it does not take place solely with regard to the reference cylinder but also to the plurality of cylinders.

The program is finally terminated in a step S48.

An ignition angle correction value IGN_COR can also be determined correspondingly in each case in the steps S6 and/or S14. In the program according to FIG. 4, a control signal can then also be determined for activating the respective spark plugs 19, and specifically depending on an ignition angle which is determined elsewhere and the ignition angle correction value IGN_COR.

What is claimed is:

1. A method for operating an internal combustion engine having a plurality of cylinders, at least one cylinder being configured as a reference cylinder to which a cylinder pressure sensor is assigned, wherein at least one control element is assigned to each of the cylinders and provision is made for a crankshaft angle sensor, the method comprising the steps of:
determining a combustion parameter depending on a measurement signal of the cylinder pressure sensor, said combustion parameter being characteristic for the combustion process of an air/fuel mixture in the reference cylinder, and
adjusting at least one control variable for at least one control element with respect to a plurality of cylinders depending on the combustion parameter to adjust the combustion process in the reference cylinder to a preset combustion process.

2. The method according to claim 1, wherein the combustion parameter is representative for a focal point of the combustion of the air/fuel mixture in the cylinder.

3. The method according to claim 2, wherein the combustion parameter is determined depending on a pressure focal point which is derived from the measurement signal of the cylinder pressure sensor and relates to the compression stroke and the working stroke of the reference cylinder.

4. The method according to claim 1, wherein the combustion parameter is representative for a velocity of the combustion of the air/fuel mixture in the reference cylinder.

5. The method according to claim 4, wherein the combustion parameter is determined depending on a maximal gradient of the pressure in the reference cylinder during the combustion of the air/fuel mixture in the reference cylinder, said gradient being derived from the measurement signal of the cylinder pressure sensor.

6. The method according to claim 1, wherein the at least one control variable for at least one control element influences an exhaust gas return or a preinjection quantity to be metered or a position of a main injection pattern relative to the crankshaft angle, or an ignition angle, with respect to the plurality of cylinders.

7. The method according to claim 1, wherein an acceleration parameter for an angular acceleration during the combustion of the air/fuel mixture in the respective cylinder is determined in a cylinder-specific manner during a quasi-stationary operation of the internal combustion engine, and at least one control variable is adjusted in a cylinder-specific manner in each case, in the sense of a balancing of the acceleration parameters assigned to the respective cylinders.

8. The method according to claim 7, wherein the at least one control variable which is to be cylinder-specifically adjusted influences a fuel quantity that is to be metered into the respective cylinder.

9. The method according to claim 7, wherein the at least one control variable which is to be cylinder-specifically adjusted influences a position, relative to the crankshaft angle, of a main injection pattern into the respective cylinder.

10. The method according to claim 7, wherein the acceleration parameter is cylinder-specifically determined depending on the angular acceleration during the combustion of the air/fuel mixture in the respective cylinder.

11. The method according to claim 7, wherein the acceleration parameter is determined depending on the time duration of an angle segment which can be preset.

12. The method according to claim 11, wherein the angle segment is the respective cylinder segment.

13. The method according to claim 1, wherein an actual torque is determined depending on the measurement signal of the cylinder pressure sensor, and a torque model whose output variables are control variables is adjusted depending on the actual torque for a plurality of cylinders.

14. A device for operating an internal combustion engine comprising:
a plurality of cylinders, wherein at least one cylinder is configured as a reference cylinder to which a cylinder pressure sensor is assigned, and at least one control element is assigned to each of the cylinders, and
a crankshaft angle sensor,
wherein the device is operable to determine a combustion parameter depending on a measurement signals of the cylinder pressure sensor, wherein said combustion parameter is characteristic for a combustion process of an air/fuel mixture in the reference cylinder, and to adjust at least one control variable for at least one control element with respect to a plurality of cylinders depending on the combustion parameter to adjust the combustion process in the reference cylinder to a preset combustion process.

15. The device according to claim 14, wherein the combustion parameter is representative for a focal point of the combustion of the air/fuel mixture in the cylinder.

16. The device according to claim 15, further comprising means to determine the combustion parameter depending on a pressure focal point which is derived from the measurement signal of the cylinder pressure sensor and relates to the compression stroke and the working stroke of the reference cylinder.

17. The device according to claim 14, wherein the combustion parameter is representative for a velocity of the combustion of the air/fuel mixture in the reference cylinder.

18. The device according to claim 17, further comprising means to determine the combustion parameter depending on a maximal gradient of the pressure in the reference cylinder during the combustion of the air/fuel mixture in the reference cylinder, said gradient being derived from the measurement signal of the cylinder pressure sensor.

19. The device according to claim 14, wherein the at least one control element influences an exhaust gas return or a preinjection quantity to be metered or a position of a main injection pattern relative to the crankshaft angle, or an ignition angle, with respect to the plurality of cylinders.

20. The device according to claim 14, further comprising means to determine an actual torque depending on the measurement signal of the cylinder pressure sensor, and a torque model whose output variables are control variables is adjusted depending on the actual torque for a plurality of cylinders.
